(19) United States
(12) Patent Application Publication
(10) Pub. No.: US 2005/0198847 A1
(43) Pub. Date: Sep. 15, 2005

(54) Parallel ruler

(76) Inventors: Te-Hsiang Liu, Hsinchu City (TW); Yu-Wen Fang, Hsinchu County (TW); Jay Heng Lin, Pingtung City (TW); Ming-Shuo Yen, Jubei City (TW)

Correspondence Address: DUANE MORRIS, LLP;IP DEPARTMENT, ONE LIBERTY PLACE, PHILADELPHIA, PA, 19103-7396, US

(21) Appl. No.: 10/800,555

(22) Filed: Mar. 15, 2004

(51) Int. Cl. G01B 5/25

(52) U.S. Cl. 33/533

(57) ABSTRACT

A parallel ruler comprises a frame, and a plurality of gauges disposed in a flat portion of the frame. The gauges have compressible parts protruding downward beyond a lower surface of the frame for measuring a distance to a plane.

### FIELD OF THE INVENTION

The present invention relates to a measurement device and more particularly to a parallel ruler used to measure a position and horizontal orientation of a plane as well as a measurement method applying the parallel ruler.

### DESCRIPTION OF RELATED ART

In order to have higher productivity, it is necessary to accurately tune a position and orientation of a plane in machines and devices to assure manufacturing specifications are met. Very often, it is important to ascertain a position and/or horizontal orientation of a specific plane in the manufacturing process, such as a surface of an electrode in electroplating and dry etching.

In the semiconductor industry, there is a continuing effort to increase yield rates by improving the control of manufacturing processes. For example, during the dry etching process as shown in FIG. 1, a wafer is disposed on the upper surface of the lower electrode 110 when the lower electrode 110 is at the load position 130. The lower electrode 110 is then raised to the process position 140. The distance of the gap 150 between the upper electrode 120 and the lower electrode 110 at the process position 140 substantially effects the etching rate. If the gap distance 150 deviates from the required value or the upper surface plane of the lower electrode 110 is slanting, the dry etching would not achieve the intended outcome. As a result, the yield rates of the semiconductor manufacturing process would decrease.

A conventional method to ascertain the gap distance 150 and the horizontal orientation of the lower electrode 110 uses jigs. In FIG. 2, three jigs 210, 220, and 230 are placed on the top of the lower electrode 110. Each jig such as 220 has a compressible part such as 222. FIG. 3 illustrates steps of the conventional measurement method. At step 310, the jigs have to be calibrated before measurement. At step 320, the jigs are placed on the lower electrode 110 at load position 130. At step 330, the cover of the dry etcher with the upper electrode 120 disposed thereon is put down to close the dry etcher. At step 340, the lower electrode 110 moves up to the process position 140. Then the compressible part of the jigs touches the upper electrode 110 and is pushed back and remain compressed. The level of compression reflects the gap distance at the position where the jig is disposed. At step 350, the lower electrode 110 moves down to the load position 130. At step 360, the cover of the dry etcher opens again. At step 370, the jigs are taken out to measure their compression.

If the difference of compression between jigs is too large, it means that the lower electrode 110 is slanting. If the compression level is different from a predetermined value, it means that the process position of the lower electrode 110 is either too close or too far away from the upper electrode 120. When either situation occurs, the result is out of specification. Then, the lower electrode 110 is accordingly adjusted. The measurement process is repeated until the lower electrode 110 is at an intended position.

The conventional measurement method has some drawbacks. First, different jigs need to be used for different machines. Secondly, it is very time consuming because the complicated steps to follow such as moving the lower electrode 110 up and down to manually measure the compression of the jigs. Thirdly, the accuracy is poor because of the measurement error and the random locations on the lower electrode 110 to place jigs.

### SUMMARY OF THE INVENTION

A parallel ruler comprises a frame and a plurality of gauges disposed in a flat portion of the frame. The gauges have compressible parts protruding downward beyond a lower surface of the frame for measuring a distance to a plane.

### BRIEF DESCRIPTION OF THE DRAWINGS

A more complete understanding of the present invention can be obtained by reference to the detailed description of embodiments in conjunction with the accompanying drawing, in which:

FIG. 1 (PRIOR ART) illustrates a cross sectional view of a dry etcher used in the semiconductor manufacturing;

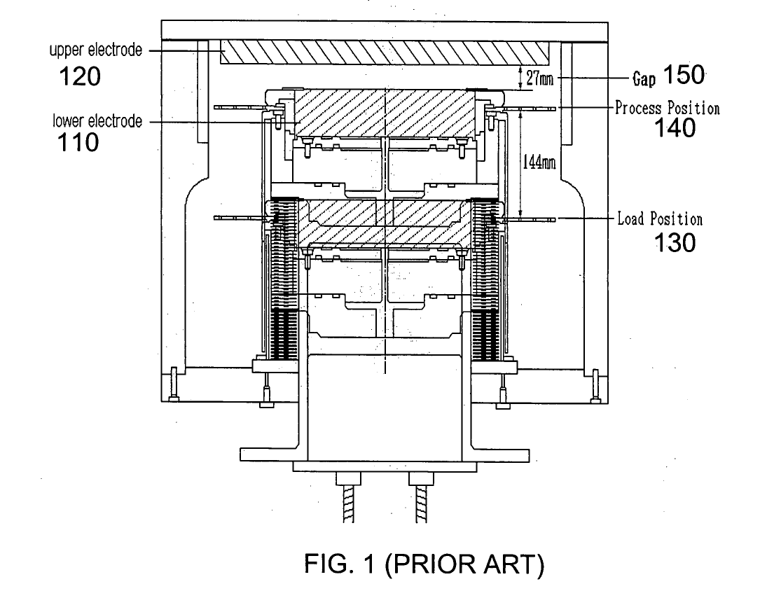

FIG. 2 (PRIOR ART) illustrates a perspective view of a dry etcher and jigs on a lower electrode of the dry etcher as shown in FIG. 1;

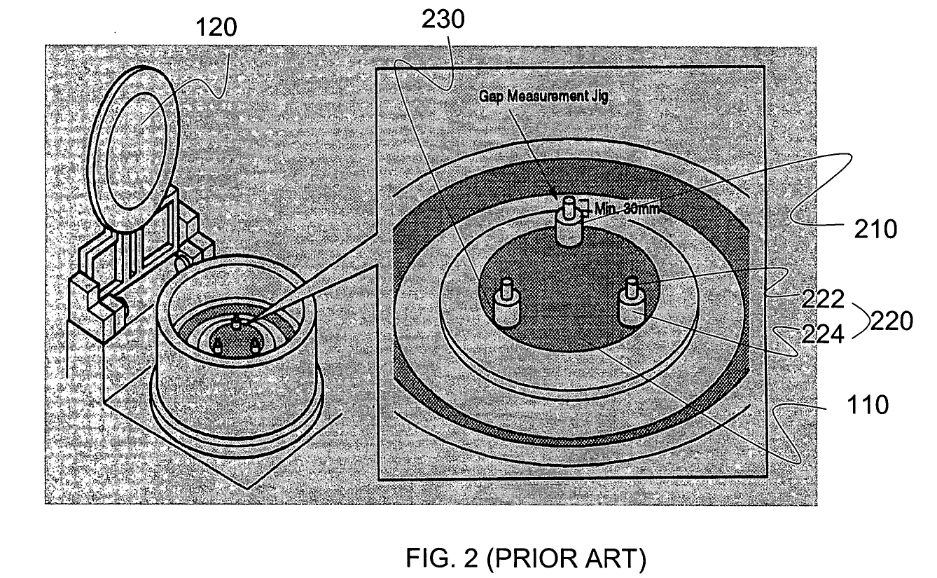

FIG. 3 (PRIOR ART) illustrates a process flow of a conventional measurement method using jigs;

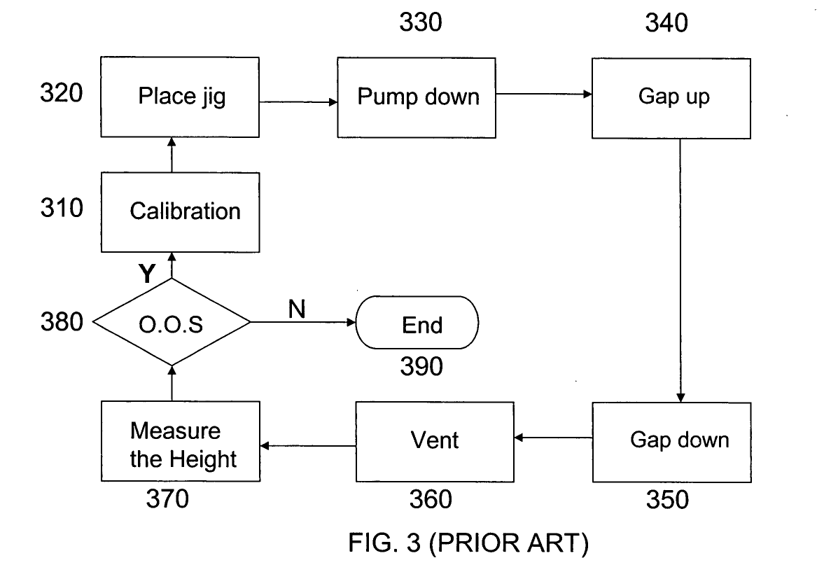

FIG. 4 illustrates a top view and a cross sectional view of an embodiment of a parallel ruler;

FIGS. 5A-5B illustrate a top view and a bottom view of a gauge hosting structure and embedded gauges as shown in FIG. 4;

FIG. 6 illustrates a perspective view and a top view of a back plunger dial indicator;

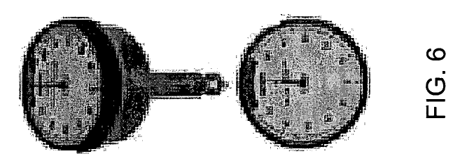

FIG. 7A illustrates a cross sectional view of a parallel ruler and a dry etcher;

FIG. 7B illustrates a top view and a cross sectional view of another embodiment of a parallel ruler with ancillary gauges in the sustaining structure;

FIG. 8 illustrates a process flow of a measurement method applying a parallel ruler.

### DETAILED DESCRIPTION OF THE INVENTION

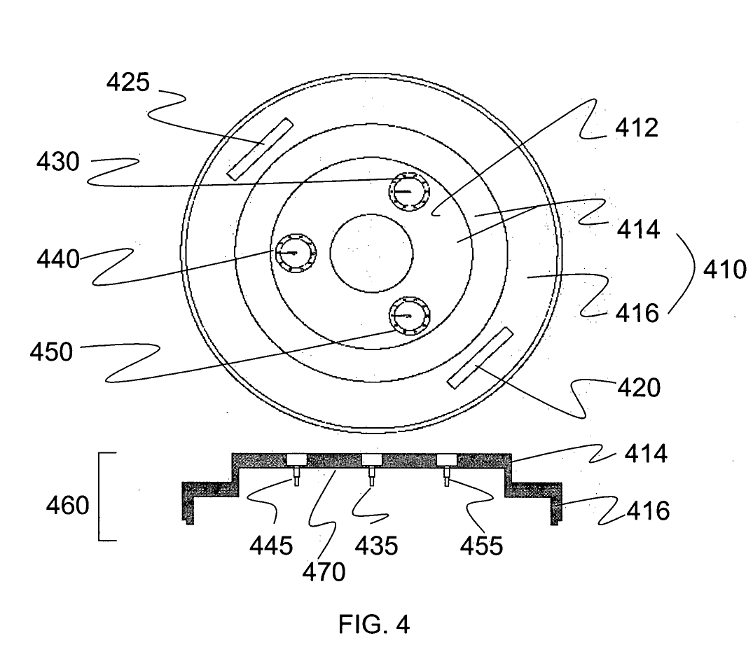

As shown in FIG. 4, an exemplary embodiment of a parallel ruler comprises a frame 410 and three gauges 430, 440, and 450. People skilled in the art know an appropriate number of gauges need to be used for a specific measurement. For example, in order to measure an orientation of a plane, at least three gauges are needed. Gauges 430, 440, and 450 are disposed in a flat portion 412 of the frame 410 with compressible parts 435, 445, and 455 protruding downward from a lower surface 470 of the frame for measuring a distance to a plane.

The frame 410 comprises a gauge hosting structure 414 which is supported by a sustaining structure 416. Both the gauge hosting structure 414 and the sustaining structure 416 are of ring shape. Skilled persons will appreciate that the shape of the gauge hosting structure 414 and the sustaining structure 416 can be rectangular or other shapes according to measurement needs. The sustaining structure 416 has two handles 420 and 425 attached thereto.

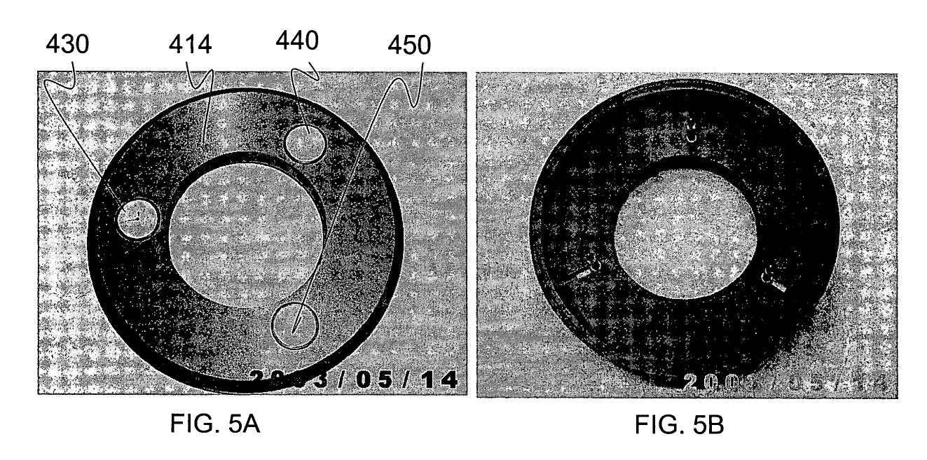

In FIG. 5A and 5B, gauges 430, 440, and 450 are disposed in the gauge hosting structure 414 approximately equidistant from adjacent gauges. People skilled in the art know appropriate positions to place gauges for a specific measurement. Besides, gauges 430, 440, and 450 have measurement indications readable from an upper surface of the frame 410. A back plunger dial indicator such as a Mitutoyo back plunger dial indicator shown in FIG. 5 can be used for gauges 430, 440, and 450. Skilled persons will appreciate that other types of gauges with compressible parts for measuring can be used.

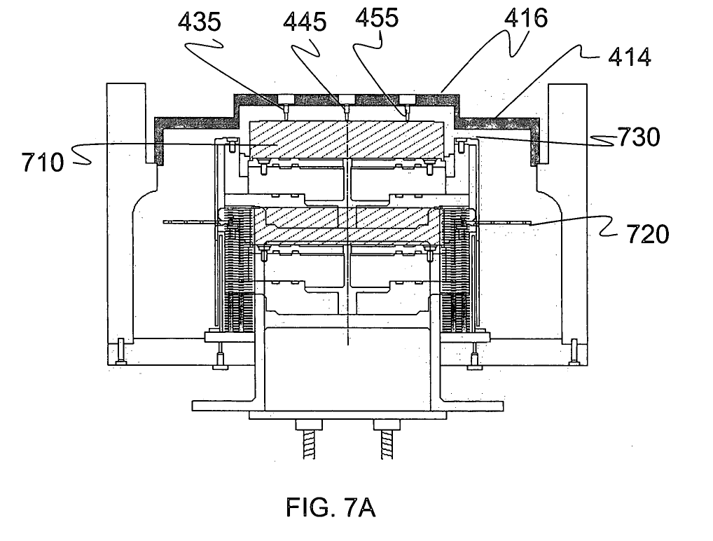

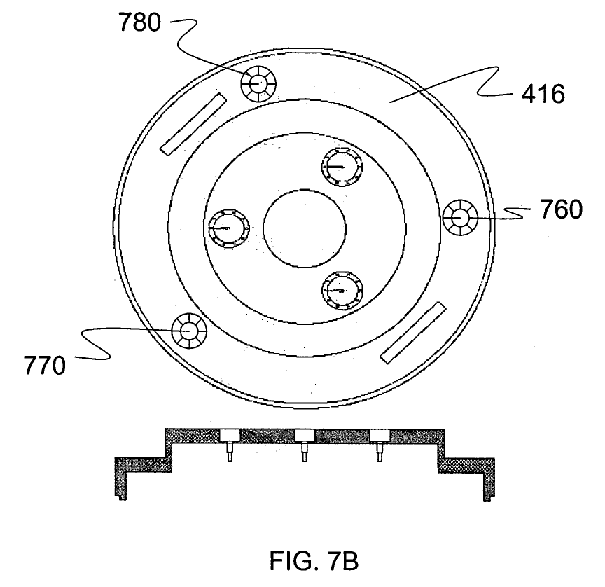

A parallel ruler can be used to measure a position and orientation of a plane. In FIGS. 7A and 7B, an exemplary embodiment of a parallel ruler is employed to measure the position and horizontal orientation of a movable cathode 710 of a dry etcher used for semiconductor manufacturing. The sustaining structure 416 is positioned inside the dry etcher. The gauge hosting structure 414 is disposed above and supported by the sustaining structure 416. In addition, FIG. 7B shows a plurality of ancillary gauges 760, 770, and 780 are disposed in the sustaining structure 416 to ascertain its horizontal orientation.

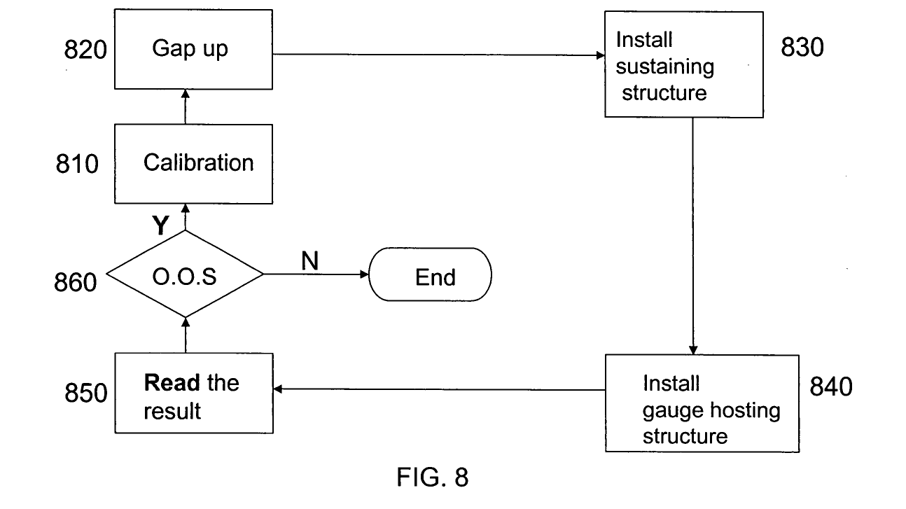

FIG. 8 demonstrates a process flow of using the parallel ruler to measure the position and horizontal orientation of a movable cathode of a dry etcher. At step 810, the parallel ruler is calibrated before it is used to measure the position and horizontal orientation of a movable cathode. With calibration, the relation between measurement data from gauges and the real position of height is articulated. For example, the parallel ruler can be calibrated with standard jigs. In one embodiment, after calibration, it is determined that 0.85 mm read from the gauge reflects a 27 mm gap as required for dry etching. As a result, the reference value is 0.85 mm in this case.

At step 820, the movable cathode 710 moves up from the load position 720 to the process position 730. At step 830, the sustaining structure 416 is installed. At step 840, the gauge hosting structure 414 is installed. The respective compressible parts 435, 445, and 455 of gauges 430, 440, and 450 are compressed by an upper surface of the movable cathode 710. The respective heights from different positions on the upper surface of the movable cathode are measured by levels of compression to the compressible parts 435, 445, and 455. At step 850, measurement data are read from gauges 430, 440, and 450.

At step 860, measurement data is compared with the reference value to decide whether the current position and horizontal orientation of the movable cathode 710 is acceptable or out of specification. If it is out of specification, the position of the movable cathode 710 is adjusted until measurement data read from gauges show that the movable cathode 710 is in the correct position. For example, when measurement data read from gauges are 1 mm, which is 0.15 mm higher than the reference value 0.85 mm, the position of the movable cathode 710 is out of specification. The movable cathode 710 is then adjusted by moving down 0.15 mm. When measurement data read from gauges 430, 440, and 450 are 0.75 mm, 0.85 mm, and 0.95 mm, the orientation of the movable cathode 710 is slanting and not horizontal. The movable cathode 710 needs to be adjusted until the measurement data read from gauges 430, 440, and 450 are all 0.85 mm. Because the measurement data can be read out directly from the upper surface of gauges, the adjustment can be done easily.

Although the invention has been described in terms of exemplary embodiments, it

1. A parallel ruler comprising:
a frame having a flat portion with an upper surface, and
a plurality of gauges disposed in the flat portion and not extending above the upper surface, the gauges having compressible parts protruding downward beyond a lower surface of the frame for measuring a distance to a plane.

2. The parallel ruler of claim 1, wherein the gauges have measurement indications which are readable from an upper surface of the frame.

3. The parallel ruler of claim 2, wherein the gauges comprise a back plunger dial indicator.

4. The parallel ruler of claim 2, wherein the frame comprises a sustaining structure and a gauge hosting structure, the gauges being disposed in the gauge hosting structure.

5. The parallel ruler of claim 4, wherein the gauge hosting structure is supported by the sustaining structure.

6. The parallel ruler of claim 4, wherein the gauge hosting structure and the sustaining structure are of ring shape.

7. The parallel ruler of claim 6, wherein the sustaining structure has handles.

8. The parallel ruler of claim 6, wherein at least three gauges are disposed in the gauge hosting structure.

9. The parallel ruler of claim 8, wherein gauges are disposed substantially equidistant from adjacent gauges.

10. The parallel ruler of claim 6, further comprising:
a plurality of ancillary gauges disposed in the sustaining structure of the frame.

11. A method of measuring a position and orientation of a plane, comprising:
disposing a parallel ruler over a plane, the parallel ruler comprising a frame and a plurality of gauges disposed in a flat portion of the frame, the gauges having measurement indicators that do not extend above an upper surface of the flat portion, and compressible parts protruding downward beyond a lower surface of the frame for measuring a distance to the plane;
measuring level of compression of the compressible parts of the gauges when at least compressible part of one gauge contacts the plane;
adjusting the plane until level of compression of the compressible parts of every gauge is approximately the same.

12. The method of claim 11, further comprising:
calibrating the parallel ruler before disposing the parallel ruler over the plane.

13. The method of claim 11, further comprising:
adjusting the plane until level of compression of the compressible parts of every gauge reaches a predetermined value.

14. The method of claim 11, wherein at least three gauges are disposed in the flat portion of the frame.

15. The method of claim 11, wherein the plane is an upper surface of a movable electrode.

16. The method of claim 11, wherein the plane is an upper surface of a movable cathode in an etching device.

17. A method to measure a position and orientation of a movable electrode, comprising:
calibrating a parallel ruler, the parallel ruler comprising a sustaining structure, a gauge hosting structure supported by the sustaining structure, and a plurality of gauges disposed in a flat portion of the gauge hosting structure, the gauges including measurement indicators that do not extend above a planar upper surface of the flat portion and having compressible parts protruding downward beyond a lower surface of the gauge hosting structure for measuring a distance to the electrode;
disposing the parallel ruler over the movable electrode;
measuring level of compression of the compressible parts of the gauges when at least compressible part of one gauge contacts the movable electrode;
adjusting the movable electrode until level of compression of the compressible parts of every gauge reaches a predetermined value.

18. The method of claim 17, wherein the movable electrode is a movable cathode in an etching device.

19. A parallel ruler comprising:
a frame having a flat portion with an upper surface, and
a plurality of gauges including measurement indicators which are readable from the upper surface of the frame, the gauges disposed in the flat portion, not extending above the upper surface and having compressible parts protruding downward beyond a lower surface of the frame for measuring a distance to a plane.
